(19) United States
(12) Patent Application Publication
(10) Pub. No.: US 2006/0153739 A1
(43) Pub. Date: Jul. 13, 2006

(54) Methods and systems for testing materials

(76) Inventors: Glen David Hilderbrand, Milford, OH (US); John D' Angelo, Cincinnati, OH (US); Timothy Decker, Lebanon, OH (US); Russell Craig Baucke, Loveland, OH (US); John W. Nelson JR., Hamilton, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 11/034,566

(22) Filed: Jan. 13, 2005

(51) Int. Cl. G01N 21/62

(52) U.S. Cl. 422/82.11

(57) ABSTRACT

Methods and systems for evaluating a material sample is provided. The system includes a material sample holder including a first flange having an aperture therethrough, a second flange having an aperture therethrough, the first and second flanges configured to frictionally hold a material sample sandwiched therebetween, a waveguide coupled to a first end of each of the first flange and the second flange, each waveguide configured to direct electromagnetic waves through respective apertures, a waveguide adapter communicatively coupled to a second end of each waveguide, and a control unit electrically coupled to the wave source, the control unit configured to control the waveguide adapter to transmit and receive electromagnetic wave signals.

### BACKGROUND OF THE INVENTION

This invention relates generally to the testing of materials and, more particularly, to methods and apparatus for evaluating material properties of radio frequency (RF) absorbent materials.

At least some known methods used for testing RF absorbent materials use samples that are formed precisely for placement inside a waveguide. Such testing methods are generally not reliable for evaluating highly conductive fillers used with low observable (LO) applications because of gaps that may exist between an outer periphery of the sample and an inner periphery of the waveguide. More specifically, the gaps may introduce unpredictable measurement errors into the test, thus, resulting in inaccurate measurements of RF reflection loss in the waveguide from highly conductive fillers.

Other known free space methods have been used to attempt to characterize conductive fillers. However, such methods generally have the disadvantage of requiring a large sample size.

### BRIEF DESCRIPTION OF THE INVENTION

In one aspect, a system for evaluating a material sample is provided. The system includes a material sample holder including a first flange having an aperture therethrough, a second flange having an aperture therethrough, the first and second flanges configured to frictionally hold a material sample sandwiched therebetween, a waveguide coupled to a first end of each of the first flange and the second flange, each waveguide configured to direct electromagnetic waves through respective apertures, a waveguide adapter communicatively coupled to a second end of each waveguide, and a control unit electrically coupled to the wave source, the control unit configured to control the waveguide adapter to transmit and receive electromagnetic wave signals.

In another aspect, a material sample holder for testing an electromagnetic energy absorbent material is provided. The material sample holder includes a first flange including a face and an aperture therethrough, the first flange is configured to mate to a first surface of a material sample. The material sample holder also includes a second flange including a face and an aperture therethrough, the second flange is configured to mate to a second surface of a material sample, wherein the first and the second flanges are configured to sandwich the material sample such that the face of the first flange engages the first surface and the face of the second flange engages the second surface.

In yet another aspect, a method of evaluating a material sample is provided. The method includes sandwiching a material sample between a transmitting waveguide flange having an aperture therethrough and in communication with a transmitting waveguide, and a receiving waveguide flange having an aperture therethrough and in communication with a receiving waveguide, the apertures are configured to be completely covered by the material sample when the sample is installed between the flanges, emitting an electromagnetic wave through the transmitting waveguide to the material sample, receiving electromagnetic energy from the electromagnetic wave through the sample, and determining a material property of the material sample using the emitted wave and the received energy.

### BRIEF DESCRIPTION OF THE DRAWINGS

FIG. 1 is a schematic illustration of an exemplary radio frequency material testing system that includes a sample holder, a first waveguide assembly, and a second waveguide assembly;

FIG. 2 is an enlarged perspective front view of the sample holder that may be used with radio frequency material testing system shown in FIG. 1;

FIG. 3 is an enlarged perspective side view of the sample holder that may be used with radio frequency material testing system shown in FIG. 1 taken along a view line shown in FIG. 2;

FIG. 4 is a graph of exemplary traces of a finite element comparison between a perfectly filled sample in a waveguide and a simulation of a measurement in accordance with one embodiment of the present invention; and

FIG. 5 is a simplified block diagram of an exemplary architecture for radio frequency material testing system.

### DETAILED DESCRIPTION OF THE INVENTION

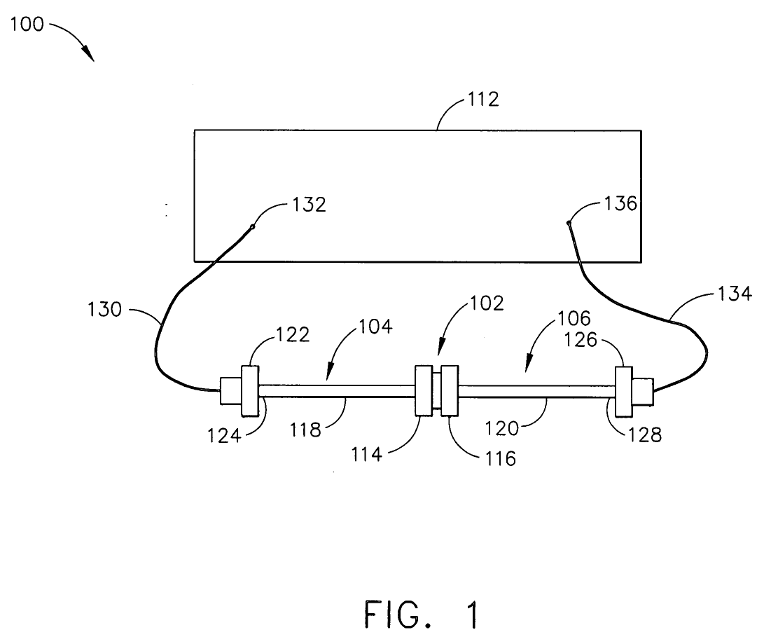

FIG. 1 is a schematic illustration of an exemplary radio frequency material testing system 100 that includes a sample holder 102, a first waveguide assembly 104, and a second waveguide assembly 106. Testing system 100 also includes a control unit 112, for example, a wave analyzer. In the exemplary embodiment, sample holder 102 is configured to sandwich a sample 113 of RF absorbent material between a first flange 114 and a second flange 116 that are maintained in position with respect to each other using a clamping device (not shown), for example, but not limited to threaded fasteners, extending from flange 114 to flange 116. Waveguides assemblies 104 and 106 each include an elongate waveguide 118 and 120 respectively, having a longitudinal bore (not shown) therethrough. Waveguide assemblies 104 and 106 are coupled to flanges 114 and 116 respectively such that an aperture through each flange 114 and 116 is oriented in substantial alignment with the longitudinal bore of respective waveguide assemblies 104 and 106. A waveguide adapter 122 is coupled to a source end 124 of waveguide 118 and a waveguide adapter 126 is coupled to a source end 128 of waveguide 120. An first analyzer test lead 130 is electrically coupled between waveguide adapter 122 and a first port 132 of control unit 112. An second analyzer test lead 134 is electrically coupled between waveguide adapter 126 and a second port 136 of control unit 112. In one embodiment, control unit 112 is a 8510C Vector Network Analyzer commercially available from Agilent Technologies, Inc., Palo Alto, Calif. In other embodiments, control unit 112 may be embodied on a computer, such as a stand-alone PC-based computer and/or a workstation in a client server relationship with a server through a network.

In operation, RF absorbent material sample 113 is sandwiched between flanges 114 and 116 and waveguide assemblies 104 and 106 are assembled such that waveguide adapter 122 is in RF communication with waveguide 118 and waveguide adapter 126 is in RF communication with waveguide 120. Each waveguide adapter 122 and 126 is coupled to respective ports 132 and 136 of control unit 112. As RF energy is transmitted through waveguide 118 toward sample 113, port 136 receives a signal from waveguide adapter 126 proportional to the RF energy that may leak through sample 113. Similarly, RF energy is transmitted through waveguide 120 toward sample 113, port 132 receives a signal from waveguide adapter 122 proportional to the RF energy that may leak through sample 113. Using the received signals, reflection loss measurements may be obtained and when combined with finite element model (FEM) waveguide code, S parameter measurements obtained, may be converted into Rf material properties using a transfer function derived from the FEM analysis.

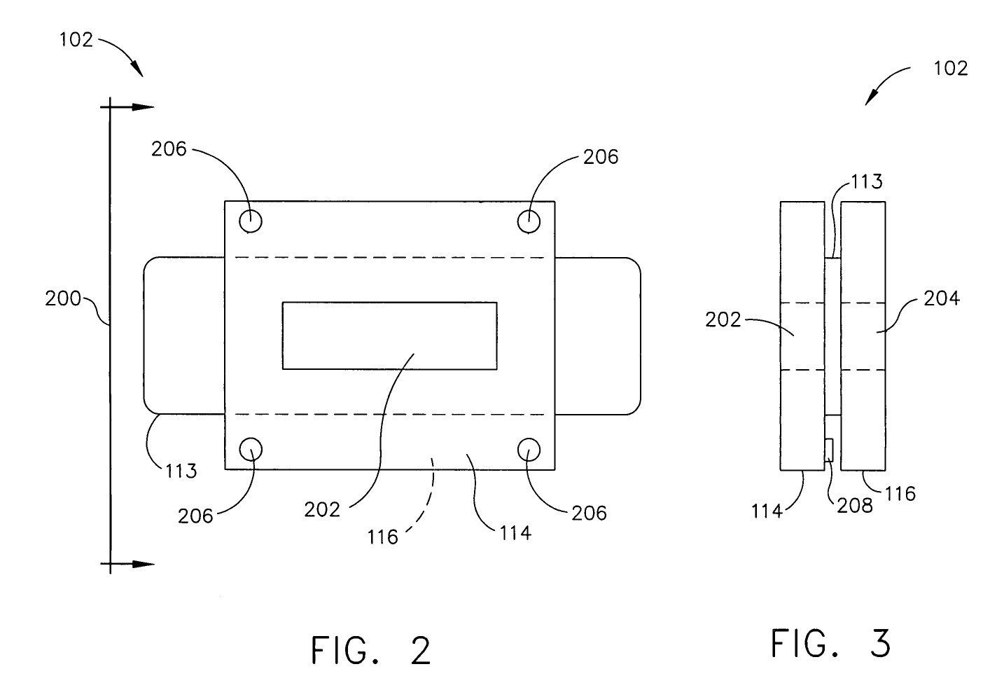

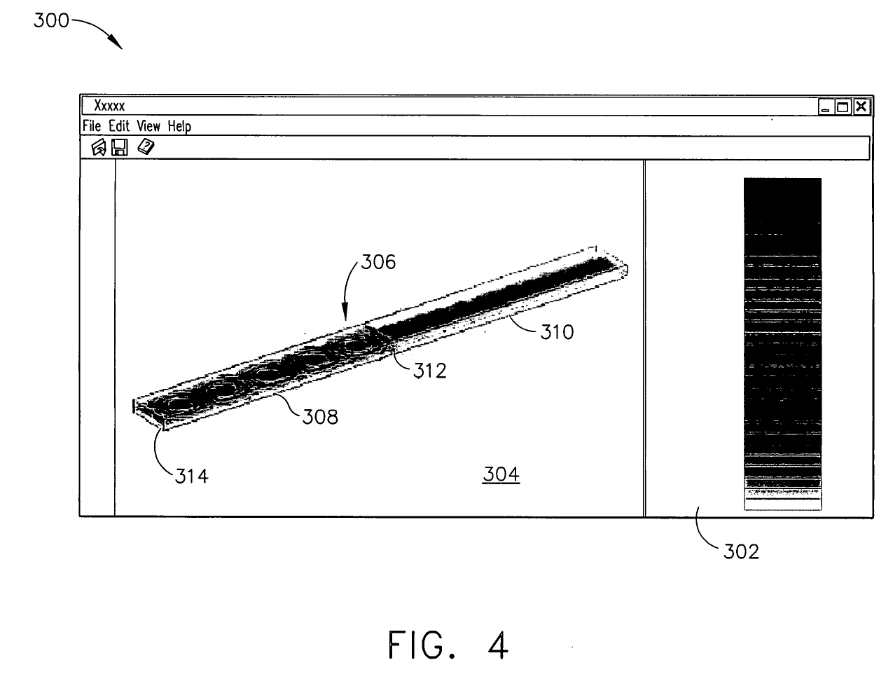

FIGS. 2 and 3 are enlarged perspective views of sample holder 102 that may be used with radio frequency material testing system 100 (shown in FIG. 1). FIG. 2 is a front view of sample holder 102 and FIG. 3 is a side view taken along a line 200 (shown in FIG. 2). Sample holder 102 includes flange 114 and flange 116. Each flange 114 and 116 includes an aperture 202 and 204 respectively. Apertures 202 and 204 are sized to couple to waveguide 118 and 120 respectively. In the exemplary embodiment, flanges 114 and 116 are substantially complementary such that apertures 202 and 204 are substantially aligned with respect to each other when sample holder 102 is assembled. Flanges 114 and 116 may each include complementary fastener holes 206 such as, apertures and/or slots. Fastener holes 206 facilitate clamping flanges 114 and 116 together with sample 113 between. Flanges 114 and 116 may also be clamped together using a separate clamping device (not shown). Sample holder 102 is configured to maintain sample 113 in a fixed position between flanges 114 and 116 using a friction force. Additionally, sample holder 102 may apply a sufficient clamping force to sample 113 such that a portion in contact with flanges 114 and 116 is compressed and a portion not in contact with flanges 114 and 116 is expanded. In such a case, the expanded portion may facilitate providing an interference fit between sample 113 and flanges 114 and 116. One or more of flanges 114 and 116 may include a compression stop 208 configured to prevent excessive compression of sample 113.

In the exemplary embodiment, aperture 202 is illustrated as having a rectangular cross-section. It should be understood that this illustration is exemplary only and aperture 202 may be any shape capable of permitting radio frequency material testing system 100 to perform the functions described herein.

FIG. 3 is a screen shot 300 of an exemplary output of a finite element model that may be used with control unit 112 (shown in FIG. 1). Screen shot 300 includes a legend 302 and an output area 304 where an output 306 of the FEM calculation is displayed. Using received signals from control unit 112, reflection loss measurements may be determined and when the reflection loss measurements are combined with a FEM waveguide code, S parameter measurements may be determined and converted into RF material properties using a transfer function derived from the FEM analysis. In the exemplary embodiment, output 306 is programmed to model radio frequency material testing system 100 and includes a transmit portion 308, a receive portion 310 and a sample portion 312. Transmit portion 308 models one of waveguide 118 or 120 during a test when the associated waveguide adapter is emitting RF energy into waveguide 118 or 120 toward sample 113. Receive portion 310 models the other of waveguide 118 or 120 during a test when the associated waveguide adapter is receiving RF energy leaking through sample 113. RF energy is emitted into transmit portion 308 from an entry portion 314 corresponding to waveguide adapter 122. A standing wave in transmit portion 308 is illustrated by gradient areas 316 that correlate the RF energy at locations within transmit portion 308 to legend 302. Similarly, RF energy received by receive portion 310 passing through sample 113 is displayed using legend 302.

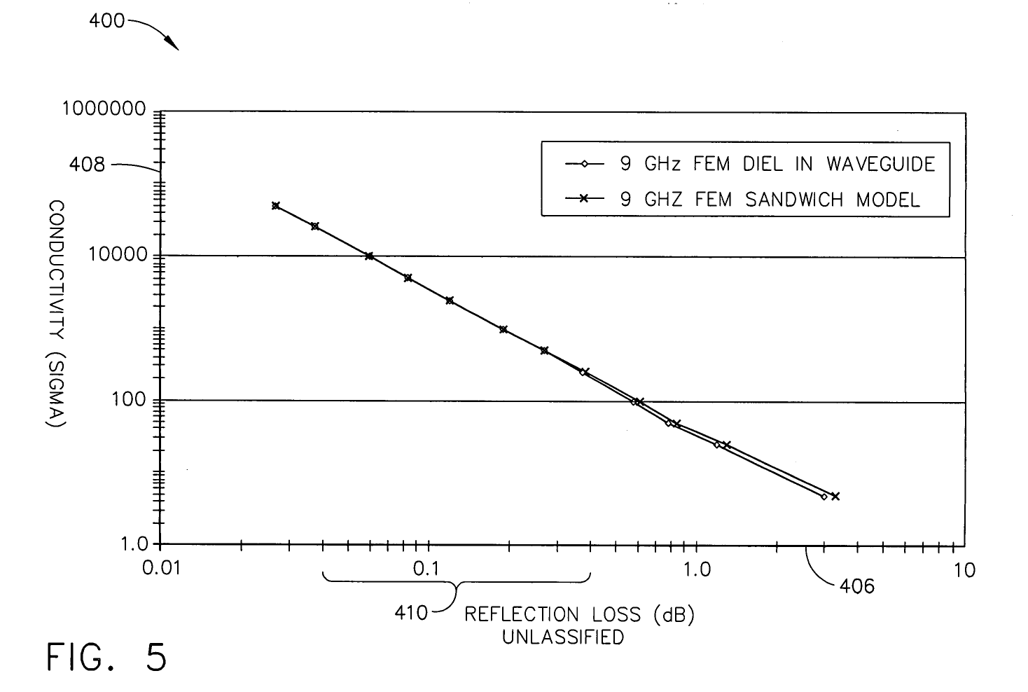

FIG. 4 is a graph 400 of an exemplary trace 402 and an exemplary trace 404 of a finite element comparison between a perfectly filled sample in a waveguide and a simulation of a measurement in accordance with one embodiment of the present invention. Graph 400 includes an x-axis 406 that indicates a reflection loss magnitude for the sample in units of dB. A y-axis 408 indicates a magnitude of conductivity of the sample corresponding to each unit of reflection loss. As illustrated, traces 402 and 404 are substantially coincident in a region of interest 410 defined between approximately 0.04 dB and approximately 0.3 of reflection loss. The close correspondence between traces 402 and 404 indicate the measurement method in accordance with one embodiment of the present invention is substantially equivalent to a simulation using a perfectly filled sample in a waveguide for highly reflective materials.

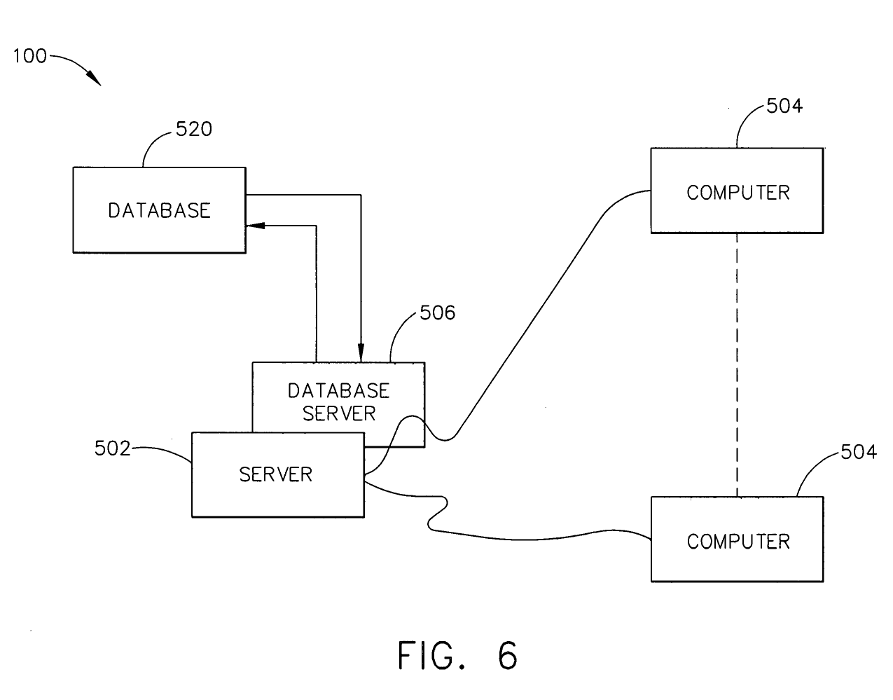

FIG. 5 is a simplified block diagram of an exemplary architecture for radio frequency material testing system 100 including a server system 502, and a plurality of client sub-systems, also referred to as client systems 504, connected to server system 502. In one embodiment, client systems 504 are computers including a web browser, such that server system 502 is accessible to client systems 504 via the Internet. Client systems 504 are interconnected to the Internet through many interfaces including a network, such as a local area network (LAN) or a wide area network (WAN), dial-in-connections, cable modems and special high-speed ISDN lines. Client systems 504 could be any device capable of interconnecting to the Internet including a web-based phone, personal digital assistant (PDA), or other web-based connectable equipment. A database server 506 is connected to a database 520 containing information on a variety of matters, as described herein. In one embodiment, centralized database 520 is stored on server system 502 and can be accessed by potential users at one of client systems 504 by logging onto server system 502 through one of client systems 504. In an alternative embodiment, database 520 is stored remotely from server system 502 and may be non-centralized.

A technical effect of the various embodiments of the invention is to automatically determine a reflection loss of a highly conductive sample using a method that facilitates reducing leakage of RF energy past the sample that would otherwise affect the accuracy of the reflection loss evaluation.

The various embodiments or components thereof may be implemented as part of a computer system. The computer system may include a computer, an input device, a display unit and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be, but not limited to, a hard disk drive, a solid state drive, and/or a removable storage drive such as a floppy disk drive, or optical disk drive. The storage device can also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer.”

The computer system executes a set of instructions that are stored in one or more storage elements, in order to process input data. The storage elements may also hold data or other information as desired or needed. The storage element may be in the form of an information source or a physical memory element within the processing machine.

The set of instructions may include various commands that instruct the processing machine to perform specific operations such as the processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

While the present invention is described with reference to RF energy absorbent conductive fillers, numerous other applications are contemplated. It is contemplated that the present invention may be applied to any material evaluation where leakage of a measurement medium past the sample may adversely affect the accuracy of the measurement and subsequent evaluation.

The above-described radio frequency material testing system is a cost-effective and highly reliable means for determining material properties of a sample. The system is configured to receive a sample sandwiched between flanges of a sample holder such that the sample completely covers the flange aperture substantially eliminating the ability of the measurement medium to bypass the sample. Accordingly, the radio frequency material testing system facilitates measuring the material properties of a sample, and in particular conductive filler material, in a cost-effective and reliable manner.

Exemplary embodiments of radio frequency material testing system components are described above in detail. The components are not limited to the specific embodiments described herein, but rather, components of each system may be utilized independently and separately from other components described herein. Each radio frequency material testing system component can also be used in combination with other radio frequency material testing system components.

While the invention has been described in terms of various specific embodiments, those skilled in the art will recognize that the invention can be practiced with modification within the spirit and scope of the claims.

What is claimed is:

1. A testing system for evaluating a material sample, said testing system comprising:
a material sample holder comprising a first flange comprising an aperture extending therethrough, a second flange comprising an aperture extending therethrough, said first and second flanges each comprise a sample face configured to frictionally retain a material sample therebetween;
a respective waveguide coupled to a first end of each of said first flange and said second flange, each said waveguide configured to direct electromagnetic waves through respective said flange apertures;
a respective waveguide adapter communicatively coupled to a second end of each waveguide; and
a control unit electrically coupled to each said waveguide adapter, said control unit configured to control said waveguide adapter to transmit and receive electromagnetic wave signals.

2. A testing system in accordance with claim 1 wherein said material sample holder is configured to hold a material sample that completely covers both said apertures.

3. A testing system in accordance with claim 1 wherein said material sample holder is configured to hold a radio frequency absorbent material.

4. A testing system in accordance with claim 1 wherein said material sample holder is configured to hold a pliable material.

5. A testing system in accordance with claim 1 wherein said material sample holder is configured to hold a compressible material.

6. A testing system in accordance with claim 1 wherein said control unit is configured to control said waveguide adapters such that when said waveguide adapter associated with said first flange is transmitting, said waveguide adapter associated with said second flange is receiving.

7. A testing system in accordance with claim 1 wherein said control unit is configured to control said waveguide adapters such that when said waveguide adapter associated with said first flange is transmitting a standing radio frequency wave, said waveguide adapter associated with said second flange is receiving radio frequency energy transmitted through a material sample.

8. A testing system in accordance with claim 1 wherein said control unit is configured to determine a reflection loss of a material sample held in said material sample holder using a radio frequency return signal.

9. A material sample holder for testing an electromagnetic energy absorbent material, said material sample holder comprising:
a first flange comprising a face and an aperture therethrough, said first flange configured to mate to a first surface of a material sample; and
a second flange comprising a face and an aperture therethrough, said second flange configured to mate to a second surface of a material sample;
said first and said second flanges configured to sandwich the material sample such that said face of said first flange engages said first surface and said face of said second flange engages said second surface.

10. A material sample holder in accordance with claim 9 wherein said first flange is configured to couple to a first waveguide such that said first flange aperture is in substantial alignment with a bore of said first waveguide.

11. A material sample holder in accordance with claim 9 wherein said second flange is configured to couple to a second waveguide such that said second flange aperture is in substantial alignment with a bore of said second waveguide.

12. A material sample holder in accordance with claim 9 wherein said first and said second flange apertures are configured to be completely covered by the material sample when said material sample holder is assembled.

13. A material sample holder in accordance with claim 9 wherein said first and said second flanges are configured to exert a clamping force on the material sample to maintain a frictional engagement between said first and said second flanges and the material sample.

14. A material sample holder in accordance with claim 9 wherein the material sample is compressible, said first and said second flanges configured to exert a clamping force on the material sample to maintain an interference fit between a portion of the material sample that is expanded by the clamping force and said first and said second flange apertures.

15. A method of evaluating a material sample, said method comprising:
sandwiching a material sample between a transmitting waveguide flange having an aperture therethrough in communication with a transmitting waveguide and a receiving waveguide flange having an aperture therethrough in communication with a receiving waveguide, the apertures configured to be completely covered by the material sample when the sample is installed in the flanges;
emitting an electromagnetic wave through the transmitting waveguide to the material sample;
receiving electromagnetic energy from the electromagnetic wave through the sample; and
determining a material property of the material sample using the emitted wave and the received energy.

16. A method in accordance with claim 15 wherein sandwiching a material sample comprises overlapping the material sample with each flange such that a portion of the material sample extends radially past an outer periphery of each aperture.

17. A method in accordance with claim 15 wherein emitting an electromagnetic wave through the transmitting waveguide comprises emitting an electromagnetic wave through a waveguide adapter coupled to an end of the transmitting waveguide opposite the transmitting waveguide flange.

18. A method in accordance with claim 15 wherein receiving electromagnetic energy from the electromagnetic wave comprises receiving an electromagnetic wave through a waveguide adapter coupled to an end of the receiving waveguide opposite the receiving waveguide flange.

19. A method in accordance with claim 15 wherein determining a material property of the material sample using the emitted wave and the received energy comprises:
controlling a frequency and power magnitude of the electromagnetic wave using an analyzer electrically coupled to the transmitting waveguide adapter;
receiving energy transmitted through the material sample at the receiving waveguide adapter; and
receiving energy reflected from the material sample at the transmitting waveguide adapter.

20. A method in accordance with claim 15 further comprising substantially blocking the emitted electromagnetic wave from impinging the receiving waveguide adapter using the material sample.
